(19) United States
(12) Patent Application Publication
(10) Pub. No.: US 2018/0322316 A1
(43) Pub. Date: Nov. 8, 2018

(54) Flat Solenoid Coil

(71) Applicant: A.K. Stamping Company, Inc., Mountainside, NJ (US)

(72) Inventor: Arthur Kurz, New Vernon, NJ (US)

(73) Assignee: A.K. Stamping Company, Inc., Mountainside, NJ (US)

(21) Appl. No.: 15/974,082

(22) Filed: May 8, 2018

Related U.S. Application Data
(60) Provisional application No. 62/503,268, filed on May 8, 2017.

(51) Int. Cl. G06K 7/08; H01F 27/28; H01F 27/29; H01F 41/04; H01F 41/10

(52) U.S. Cl. CPC G06K 7/087; H01F 27/2804; H01F 27/29; H01F 2027/2809; H01F 41/041; H01F 41/10; H01F 27/2885

(57) ABSTRACT

The present disclosure relates to a flat solenoid coil and methods for manufacturing thereof. More specifically, the present disclosure relates to a magnetic secure transmission flat solenoid coil and could include an MST coil having traces forming a flattened spiral coil, a ferrite shield disposed between the traces of the flattened spiral coil, and leadouts attached to the MST coil.

### RELATED APPLICATIONS

This application claims priority to U.S. Provisional Patent Application No. 62/503,268, filed on May 8, 2017, the entire disclosure of which is hereby expressly incorporated by reference.

### BACKGROUND

### Field of the Disclosure

The present disclosure relates to a flat solenoid coil and methods for manufacturing thereof. More specifically, the present disclosure relates to a magnetic secure transmission flat solenoid coil.

### RELATED ART

As mobile devices have become increasingly prevalent, many of these devices are being equipped with mobile payment technology. One form of mobile payment technology, magnetic secure transmission (“MST”), has been utilized by device manufacturers to enable a mobile device to communicate with legacy credit card readers. More specifically, MST technology enables a mobile device to appear to a legacy credit card reader as a conventional credit card by emulating what occurs when the magnetic strip of a credit card is swiped in a legacy credit card reader. MST technology includes small metal coils (e.g., solenoid coils) which are bent into a loop. When electricity is passed through the coil, a magnetic field is created which can communicate with the legacy credit card readers.

What would be desirable, but has not yet been developed, is an improved MST solenoid coil and methods for manufacturing thereof.

### SUMMARY

The present disclosure relates to a flat solenoid coil and methods for manufacturing thereof. More specifically, the present disclosure relates to a magnetic secure transmission flat solenoid coil and could include an MST coil having traces forming a flattened spiral coil, a ferrite shield disposed between the traces of the flattened spiral coil, and leadouts attached to the MST coil.

### BRIEF DESCRIPTION OF THE DRAWINGS

The foregoing features of the disclosure will be apparent from the following Detailed Description, taken in connection with the accompanying drawings, in which:

FIG. 1 is an exploded view illustrating components of a stamped MST coil according to the present disclosure;

FIG. 2 is an assembled schematic view of the stamped MST coil of FIG. 1;

FIG. 3 is a schematic view of a lanced MST coil after a first stamping operation according to the present disclosure;

FIG. 4 is a close-up schematic view of the lanced MST coil of FIG. 3;

FIG. 5 is a schematic view of the lanced MST coil of FIG. 3 after a second stamping operation;

FIG. 6 is a close up schematic view of the lanced MST coil of FIG. 5;

FIG. 7 is a schematic view of a leadout according to the present disclosure;

FIG. 8 is a schematic view of an assembled lanced MST coil according to the present disclosure;

FIG. 9 is a schematic view of another lanced MST coil according to the present disclosure; and

FIG. 10 is a schematic view of another stamped MST coil according to the present disclosure.

### DETAILED DESCRIPTION

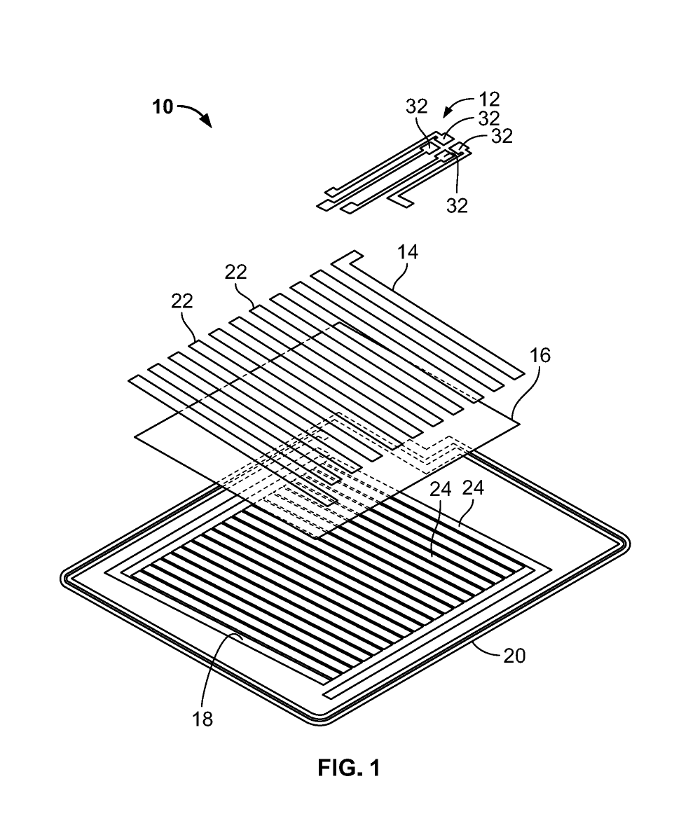

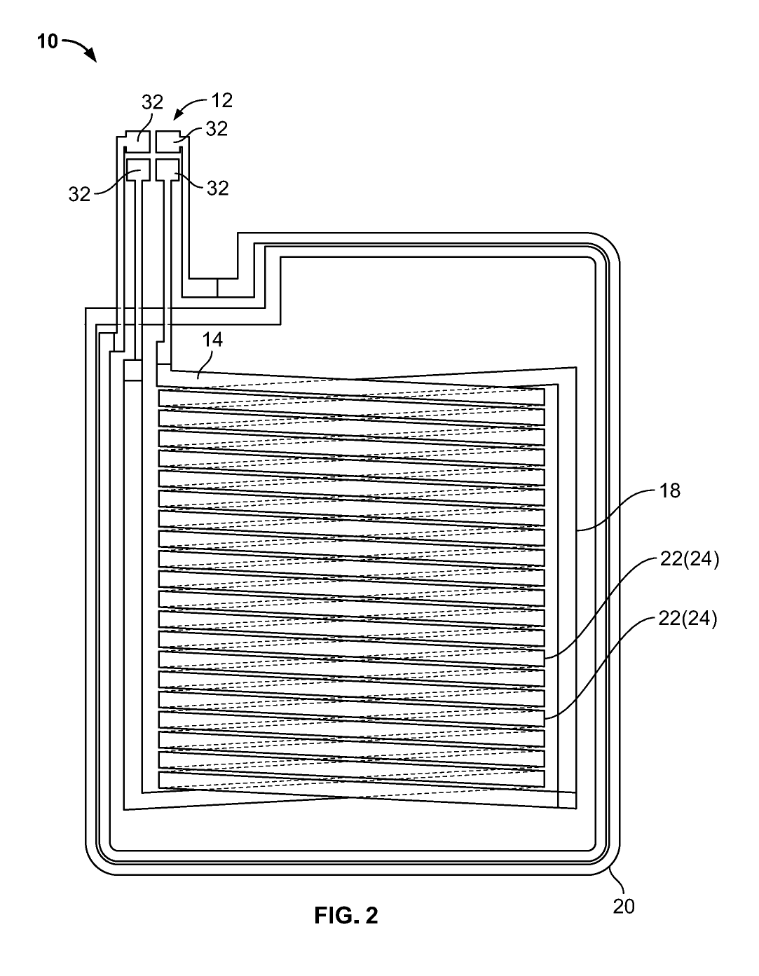

FIGS. 1-2 illustrate a stamped magnetic secure transmission (“MST”) coil, generally indicated at 10, and methods for manufacturing thereof, according to the present disclosure. FIG. 1 is an exploded view showing components of the stamped MST coil 10. As shown in FIG. 1, the stamped MST coil 10 could include leadouts 12, a top MST coil half 14 having traces 22, a ferrite shield 16, and a bottom MST coil half 18 having traces 24. As shown, the ferrite shield 16 is positioned between the top MST coil half 14 and the bottom MST coil half 18. Importantly, the top MST coil half 14 forms a first half of a flattened spiral coil and the bottom MST coil half 18 forms a second half of a flattened spiral coil. According to some aspects of the present disclosure, the stamped MST coil 10 could also include a near field communication (“NFC”) coil 20. The stamped MST coil 10 could be provided with or without NFC coil 20 without hindering operation thereof.

FIG. 2 is an assembled schematic view of the stamped MST coil 10. As illustrated in FIG. 2, the ferrite shield 16 (not shown) is positioned between the top MST coil half 14 and the bottom MST coil half 18. According to some aspects of the invention, the top MST coil half 14 could be approximately 36 mm wide and 41.4 mm high, and the bottom MST coil half 18 could be approximately 50 mm wide and 60 mm wide, although additional configurations are possible without departing from the spirit and scope of the present disclosure. As shown, the traces 22 of the top MST coil half 14 and the traces 24 of the bottom MST coil half 18 overlap at their lateral ends which extend beyond the ferrite shield 16. Overlapping portions of the traces 22, 24 are soldered together, thereby forming a continuous flattened spiral coil surrounding the ferrite shield 16. The leadouts 12 are attached to terminating ends of the top MST coil half 14 and bottom MST coil half 18 for providing a connection to another electrical device, for example, a motherboard of a mobile device. According to some aspects of the invention, leadouts 12 can also be attached to terminating ends of the NFC coil 20, if NFC coil 20 is provided.

According to some aspects of the present disclosure, a method of manufacturing the MST coil 10 is provided. The top MST coil half 14 is formed according to a first stamping operation, the bottom MST coil half 18 if formed according to a second stamping operation, and the leadouts 12 are formed according to a third stamping operation. The top MST coil half 14 and the bottom MST coil half 18 could be formed from a sheet of copper material (e.g., C110 copper having a thickness of 0.1 mm) or any other suitable material for forming solenoid coils known to those of ordinary skill in the art. The ferrite shield is positioned between the top MST coil half 14 and the bottom MST coil half 18 and the traces 22, 24 of the top MST coil half 14 and the bottom MST coil half 18 are positioned such that their lateral ends overlap and extend beyond the ferrite shield 16. After positioning the ferrite shield between the top coil half 14 and bottom coil half 18, overlapping portions of the traces 22, 24 are then soldered together, or attached by other suitable means known to those of ordinary skill in the art, thereby forming a continuous flattened spiral coil surrounding the ferrite shield 16. The leadouts 12 are then attached to terminating ends of the top MST coil half 14 and bottom MST coil half 18. The leadouts 12 could be formed by way of a stamping operation and could be made from nickel plated with gold, or another suitable material known to those of ordinary skill in the art. The leadouts 12 could be attached to the top MST coil half 14 and bottom MST coil half 18 using ultrasonic welding, soldering, or other suitable attachment operations. The leadouts 12 could be provided with solder pads 32, which could be tin plated, or could be reflowed with solder. The leadouts 12 could also be attached to NFC coil 20.

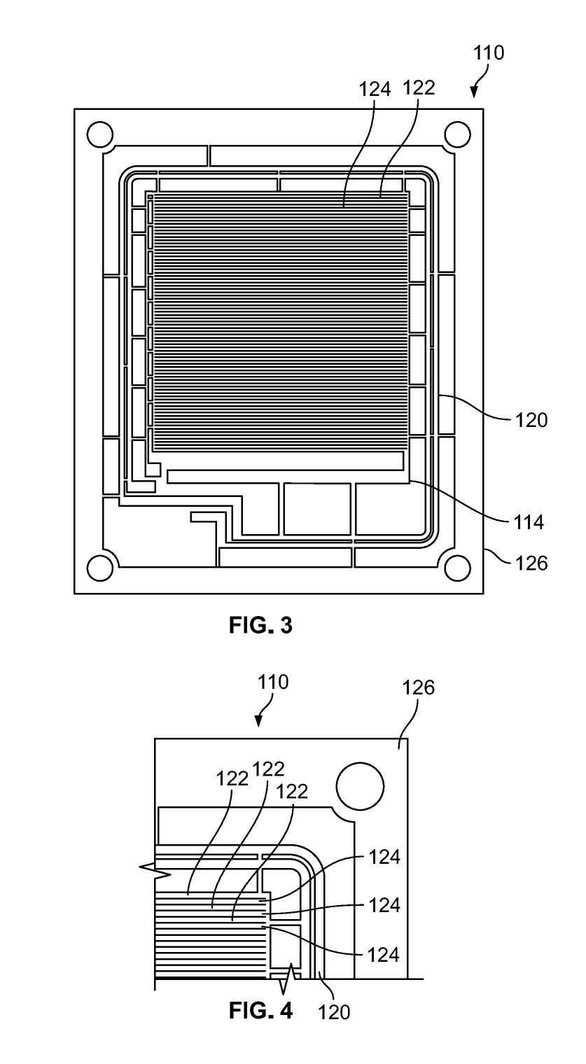

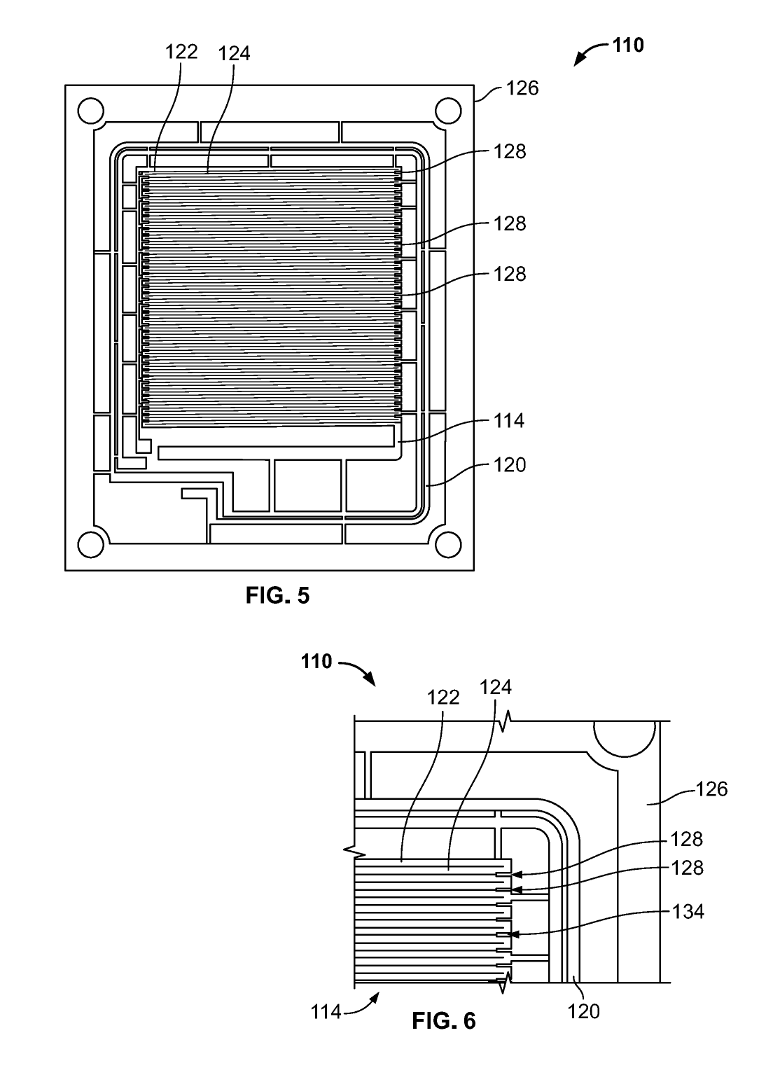

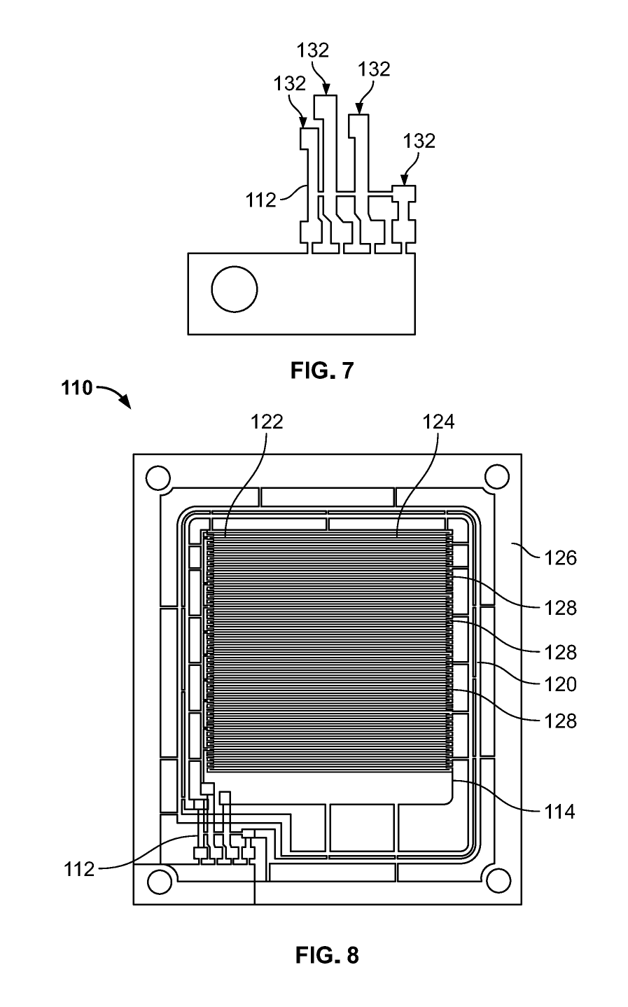

FIGS. 3-8 illustrate a lanced MST coil, generally indicated at 110, according to the present disclosure and methods for manufacturing thereof. FIG. 3 is a schematic view of the lanced MST coil 110 after a first stamping operation according to the present disclosure. FIG. 4 is a close-up schematic view of the lanced MST coil 110 of FIG. 3. FIG. 5 is a schematic view of the lanced MST coil 110 of FIG. 3 after a second stamping operation. FIG. 6 is a close up schematic view of the lanced MST 110 coil of FIG. 5. FIG. 7 is a schematic view of a leadout according to the present disclosure. FIG. 8 is a schematic view of an assembled lanced MST coil according to the present disclosure.

As shown in FIG. 3, the lanced MST coil 110 could include an MST coil 114 having traces that will form a flattened coil. The MST coil 110 can comprise, for example, thirty-eight (38) turns and can have an inductance of about 18 μH (with the ferrite shield 116) and a DC resistance of about 1.2 ohms, although additional configurations are possible without departing from the spirit and scope of the present disclosure. The traces could be stamped to bulge upwardly and downwardly. A ferrite shield 116 (not shown) is placed between the upward and downward traces and leadouts 112 (see FIG. 7) are attached thereto. The ferrite shield 116 is positioned between the upwardly biased traces 122 and the downwardly biased traces 124 (e.g., the ferrite shield is weaved between the upwardly biased traces 122 and the downwardly biased traces 124). Importantly, the upwardly biased traces 122 and the downwardly biased traces 124 form continuous flattened spiral coil around the ferrite shield 116. According to some aspects of the present disclosure, the lanced MST coil 110 could also include an NFC coil 120. The NFC coil 120 can comprise, for example, two (2) turns and can have an inductance of about 1 μH, although additional configurations are possible without departing from the spirit and scope of the present disclosure. The lanced MST coil 110 could be provided with or without NFC coil 120 without hindering operation thereof.

FIGS. 5 and 6 are schematic views of the lanced MST coil 110 of FIG. 3 after a second stamping operation. More specifically, cutouts 128 are removed from lateral sides of the upwardly biased traces 122 and the downwardly biased traces 124 thereby forming a continuous flattened spiral coil and providing an electrical path for operation of the coil 110.

As shown in FIGS. 7 and 8, the leadouts 112 can be attached to terminating ends of the MST coil 114 for providing a connection to another electrical device, such as for example, a motherboard of a mobile device. According to some aspects of the invention, the leadouts 112 can also be attached to terminating ends of the NFC coil 120, if NFC coil 120 is provided.

According to some aspects of the present disclosure, a method of manufacturing the lanced MST coil 10 is provided. In a first stamping operation, the MST coil 114 and carrier frame 126 are formed by removing portions of material surrounding the exterior of the MST coil 114. The MST coil 114 could be formed from a sheet of copper material (e.g., C110 copper having a thickness of 0.1 mm) or any other suitable material for forming solenoid coils known to those of ordinary skill in the art. The NFC coil 120 could also be formed during this first operation. The upwardly biased traces 122 and the downwardly biased traces 124 could also be formed during this first stamping operation by lancing alternating sections of the material of the MST coil 114 in upwards and downwards directions. After the material is lanced and the MST coil 114 is formed, the MST coil 114 is placed in a fixture (not shown) to “open” every other trace. After the MST coil 114 has been placed in the fixture, the ferrite shield 116 is positioned between the “opened” upwardly biased traces 122 and the downwardly biased traces 124 (e.g., the ferrite shield is weaved between the upwardly biased traces 122 and the downwardly biased traces 124). A stiffening backing 134, which can be formed from plastic, is then applied to the MST coil 114 to support the traces and to prevent the traces 122, 124 from contacting one another and “shorting out” the coil 110 during operation. The backing 134 could be applied about the perimeter, as two strips of material on either lateral side of the ferrite shield 116, or as a single piece of material, or “card,” to the back of the MST coil 114.

After the backing 134 is applied, the cutouts 128 are formed in a second stamping operation, thereby forming a continuous flattened spiral coil and providing an electrical path for operation of the coil 110. The leadouts 112 are then attached to terminating ends of the MST coil 114. The leadouts 112 could be formed by way of a stamping operation and could be made from nickel plated with gold, or another suitable material known to those of ordinary skill in the art. The leadouts 112 could be attached to the MST coil 114 using ultrasonic welding, soldering, or other suitable attachment operations. The leadouts 112 could be provided with solder pads 132, which could be tin plated, or could be reflowed with solder. The leadouts 112 could also be attached to NFC coil 120. After the leadouts have been attached to MST coil 114, external tie bars 130 can be severed, thereby releasing the lanced MST coil 110 from the carrier frame 126.

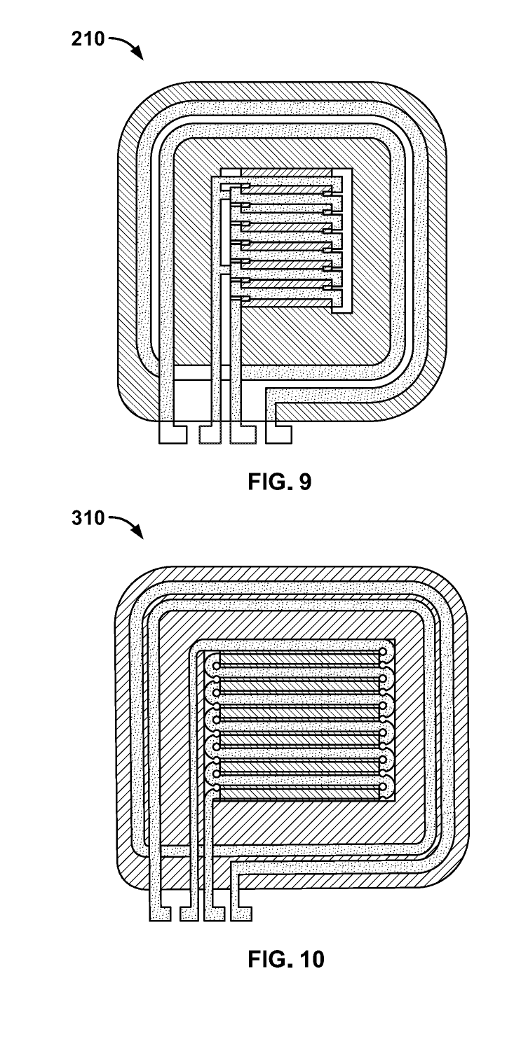

FIGS. 9-10 are schematic views illustrating additional aspects of the present disclosure. More specifically, FIG. 9 is a schematic view of another lanced MST coil, indicated generally at 210, according to the present disclosure and FIG. 10 is a schematic view of another stamped MST coil, indicated generally at 310, according to the present disclosure.

Having thus described the device and methods of manufacturing in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

1. A magnetic secure transmission device, comprising:
a flattened top coil half having a series of traces;
a flatten bottom coil half having a series of traces;
a ferrite shield positioned between the top coil half and the bottom coil half; and
electrical leads connected to the top coil half and the bottom coil half;
the traces of the top coil half and the bottom coil half together forming a continuous flattened spiral coil surrounding the ferrite shield.

2. The device of claim 1, further comprising a near field communication coil.

3. The device of claim 1, wherein lateral ends of the traces of the top coil half and the bottom coil half extend over the ferrite shield and overlap each other.

4. The device of claim 3, wherein the overlapping lateral ends of the traces of the top coil half and the bottom coil half are attached, thereby forming the continuous flattened spiral coil.

5. The device of claim 1, wherein the leads are electrically connected to terminating ends of the top coil half and the bottom coil half.

6. The device of claim 2, wherein the leads are electrically connected to terminating ends of the near field communication coil.

7. A method of manufacturing a magnetic secure transmission device, comprising the steps of:
forming a flattened top coil half having a series of traces according to a first stamping operation;
forming a flattened bottom coil half having a series of traces according to a second stamping operation;
positioning a ferrite shield between the top coil half and the bottom coil half; and
attaching the top coil half to the bottom coil half, thereby forming a continuous flattened spiral coil surrounding the ferrite shield.

8. The method of claim 7, further comprising forming electrical leads according to a third stamping operation and attaching the electrical leads to the top coil half and the bottom coil half.

9. The method of claim 8, wherein the electrical leads are formed from nickel plated from gold.

10. The method of claim 8, wherein the electrical leads are attached to the top coil half and the bottom coil half using ultrasonic welding or soldering.

11. The method of claim 8, wherein the electrical leads are provided with tin-plated or reflowed solder pads.

12. The method of claim 8, further comprising attaching the electrical leads to a near field communication coil.

13. A method of manufacturing a magnetic secure transmission device, comprising the steps of:
forming a flattened coil according to a first stamping operation, the flattened coil having a series of upwardly biased traces and downwardly biased traces;
forming electrical leads according to a second stamping operation;
positioning a ferrite shield between the upwardly biased traces and downwardly biased traces, thereby forming a continuous flattened spiral coil around the ferrite shield; and
attaching the electrical leads to the continuous flattened spiral coil.

14. The method of claim 13, further comprising a third stamping operation forming cutouts in lateral ends of the upwardly biased traces and downwardly biased traces, thereby providing an electrical path for operation of the magnetic secure transmission device.

15. The method of claim 13, further comprising forming a near field communication coil according to the first stamping operation.

16. The method of claim 15, further comprising attaching the electrical leads to the near field communication coil.

17. The method of claim 13, further comprising positioning the flattened coil in a fixture and opening the series of upwardly biased traces and downwardly biased traces.

18. The method of claim 13, further comprising applying a backing to the flattened coil, the backing preventing the upwardly biased traces and downwardly biased traces from contacting one another.

19. The method of claim 18, wherein the backing is applied as strips of material about a perimeter of the ferrite shield.

20. The method of claim 19, wherein the backing is applied as a single piece of material to a rear side of the magnetic secure transmission device.
